(19) United States
(12) Patent Application Publication
(10) Pub. No.: US 2023/0068597 A1
(43) Pub. Date: Mar. 2, 2023

(54) CRYPTOCURRENCY SYSTEM AND METHOD FOR PERFORMING FINANCIAL TRANSACTIONS

(71) Applicant: Weikeng Chen, Berkeley, CA (US)

(72) Inventor: Weikeng Chen, Berkeley, CA (US)

(21) Appl. No.: 17/853,993

(22) Filed: Jun. 30, 2022

Related U.S. Application Data
(60) Provisional application No. 63/237,150, filed on Aug. 26, 2021.

(51) Int. Cl. G06Q 20/38; G06Q 20/06

(52) U.S. Cl. CPC G06Q 20/3829; G06Q 20/389; G06Q 20/065

(57) ABSTRACT

A cryptocurrency system and method for performing financial transactions is disclosed. The method includes receiving a request for performing a financial transaction with respect to a decentralized account associated with a sender and first set of parties. Further, the method includes performing the financial transaction by transferring the secret share key associated with each of the sender and the first set of parties to at least one of a recipient and a second set of parties. Also, the method includes recovering the account private key at the recipient and the second set of parties' side using the secret share key associated with each of the sender and the first set of parties. Further, the method includes discarding the secret share key of the account private key at the sender and the first set of parties' side.

### EARLIEST PRIORITY DATE

This application claims priority from a Provisional patent application filed in the United States of America having Patent Application No. 63/237,150, filed on Aug. 26, 2021, and titled “CRYPTOCURRENCY SYSTEM AND METHOD FOR PERFORMING FINANCIAL TRANSACTIONS”.

### FIELD OF INVENTION

Embodiments of the present disclosure relate to cryptocurrency systems and more particularly relates to a cryptocurrency system and method for performing financial transactions.

### BACKGROUND

A cryptocurrency is a digital asset designed to work as a medium of exchange that uses cryptography to secure transactions, control creation of the digital assets, and verify the transfer of the assets. Unlike conventional centralized currency and central banking systems, cryptocurrencies typically utilize decentralized processing through a distributed ledger technology, such as a blockchain, that serves as a public transaction database. In one conventional approach, a sender broadcasts a transaction to peer-to-peer network, and full blockchain nodes may include this transaction in a new block of the blockchain. In many such cryptocurrencies, the sender must pay a transaction fee (e.g., a few dollars) in addition to the actual payment, which is to incentive the full blockchain nodes to include this transaction. Then, the transaction is considered validated when it eventually appears in stable part of the blockchain. A receiver needs to wait for this to happen, called “confirmation”. For example, in Bitcoin, for the receiver to be sure that the coins are surely being transferred, the receiver should wait for one hour.

In another conventional approach used by for example, Coinbase, called “off-chain sends”, when a Coinbase sender sends money to another Coinbase sender, no actual blockchain transaction occurs. Instead, the Coinbase modifies balance on their database directly. The reason behind Coinbase capable to perform in this manner is that the senders do not have the account private keys, however the Coinbase has all the accounts' private keys. Hence, Coinbase is the actual keeper of all the coins. This is similar to traditional banks where money transfers can be done internally, without interactions with other parties. Therefore. the Coinbase need not pay the transaction fees or wait for the transactions to be confirmed, because the transaction here is a database read or write on the Coinbase's end.

However, this conventional approach is centralized, and the users may lose money if the Coinbase is hacked. As the Coinbase has all the accounts' private keys. and the Coinbase indeed can technically spend users' money in any way it wishes. Even if the Coinbase is an honest company, a malicious employee or an external hacker may break into Coinbase's system, steal all the accounts' private keys. and then transfer Coinbase users' money to their own accounts. There is a very high risk associated with this centralized approach.

Centralization is not the original intention of blockchain systems, and a centralized solution is likely not welcome by traditional cryptocurrency users. It is also risky for the users who have a huge amount of money.

Hence, there is a need for an improved cryptocurrency system and method for performing financial transactions in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a cryptocurrency system for performing financial transactions is disclosed. The cryptocurrency system includes one or more hardware processors and a memory coupled to the one or more hardware processors. The memory includes a plurality of modules in the form of programmable instructions executable by the one or more hardware processors. The plurality of modules include a request handler module configured for receiving a request for performing a financial transaction with respect to a decentralized account associated with a sender and first set of parties. Each of the sender and the first set of parties own a secret share key of an account private key associated with the decentralized account. Further, the plurality of modules include a financial transaction management module configured for performing the financial transaction by transferring the secret share key associated with each of the sender and the first set of parties to at least one of a recipient and a second set of parties. Furthermore, the plurality of modules include a decentralized account management module configured for recovering the account private key at the recipient and the second set of parties' side using the transferred secret share key associated with each of the sender and the first set of parties. The decentralized account management module is also configured for discarding the secret share key of the account private key at the sender and the first set of parties' side upon recovering the account private key at the recipient side and the second set of parties' side.

In accordance with another embodiment of the present disclosure, a cryptocurrency-based method for performing financial transactions in cryptocurrency systems is disclosed. The cryptocurrency-based method includes receiving, by a processor, a request for performing a financial transaction with respect to a decentralized account associated with a sender and first set of parties. Each of the sender and the first set of parties own a secret share key of an account private key associated with the decentralized account. Further, the cryptocurrency-based method includes performing, by the processor, the financial transaction by transferring the secret share key associated with each of the sender and the first set of parties to at least one of a recipient and a second set of parties. Also, the cryptocurrency-based method includes recovering, by the processor, the account private key at the recipient and the second set of parties' side using the transferred secret share key associated with each of the sender and the first set of parties. Further, the cryptocurrency-based method includes discarding, by the processor. the secret share key of the account private key at the sender and the first set of parties' side upon recovering the account private key at the recipient side and the second set of parties' side.

Embodiment of the present disclosure also provide a non-transitory computer-readable storage medium having instructions stored therein that, when executed by a hardware processor, cause the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary block chain network for managing financial transactions, in accordance with an embodiment of the present disclosure;

FIG. 2 is a block diagram illustrating an exemplary cryptocurrency system, such as those shown in FIG. 1, capable of performing financial transactions, in accordance with an embodiment of the present disclosure;

FIG. 3 is a process flow diagram illustrating an exemplary cryptocurrency-based method for performing financial transactions, in accordance with an embodiment of the present disclosure;

FIG. 4 is a schematic representation of blockchain network depicting process of performing financial transactions, in accordance with an embodiment of the present disclosure;

FIG. 5A-B is a schematic representation depicting a process of performing financial transaction, in accordance with another embodiment of the present disclosure;

FIG. 6A-B is a schematic representation depicting a process of preventing double-spending attack, in accordance with an embodiment of the present disclosure;

FIG. 7 is a block diagram illustrating an exemplary process for generating decentralized accounts, in accordance with an embodiment of the present disclosure; and

FIG. 8 is a block diagram illustrating an exemplary process for transferring secret share keys from a sender and first set of parties to a recipient and a second set of parties, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”. “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure disclose a cryptocurrency system and method for performing financial transactions. The present disclosure enables sending cryptocurrency without incurring transaction fees and preserves decentralization (no single third-party knows all the secrets needed to send the transaction). In the present disclosure, users do not own the spending keys. Rather, the users and some reliable servers secret-share the spending keys of some accounts. In this case, “secret-share” means that each user knows a “share” of the spending keys, and an insufficient number of parties cannot reconstruct the spending keys, however a sufficient number of parties reconstructs the spending keys and perform computation over it. When the user wishes to transfer money, these servers and the user give the recipient the spending keys of these accounts, which does not incur a blockchain transaction and therefore avoids the transaction fees. The present disclosure involves three protocols, firstly, to convert existing non-decentralized accounts to decentralized accounts, secondly to transfer the ownership of decentralized accounts completely to a recipient and N parties and lastly to convert decentralized accounts back to non-decentralized accounts. Each of these protocols enable to perform the financial transactions to avoid transaction fees, prevent double spending attacks and avoid waiting time for confirmation.

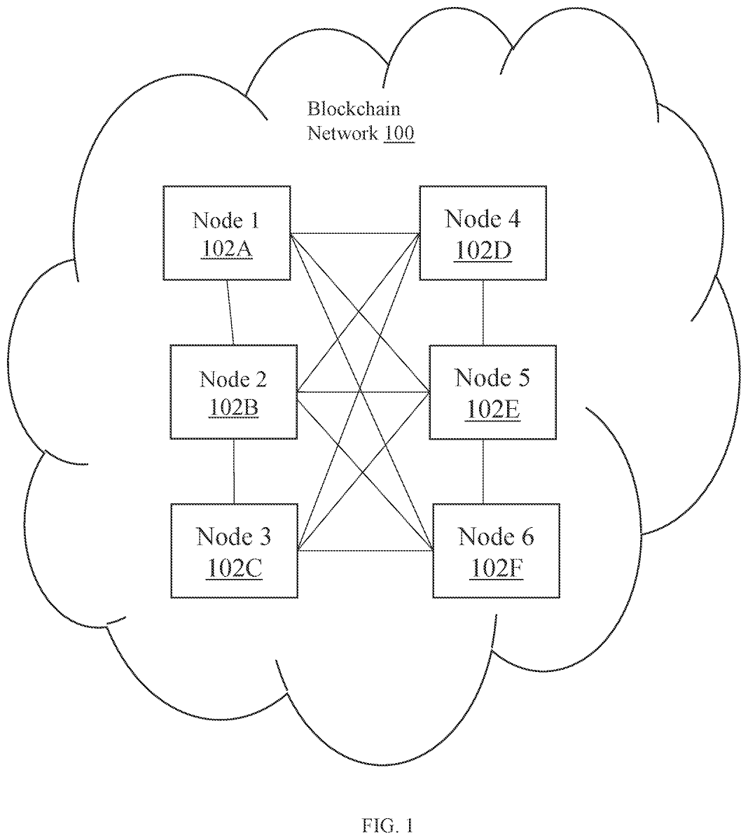

Referring now to the drawings, and more particularly to FIGS. 1 through 8, where similar reference characters denote corresponding features consistently throughout the figures, there are shown preferred embodiments and these embodiments are described in the context of the following exemplary system and/or method.

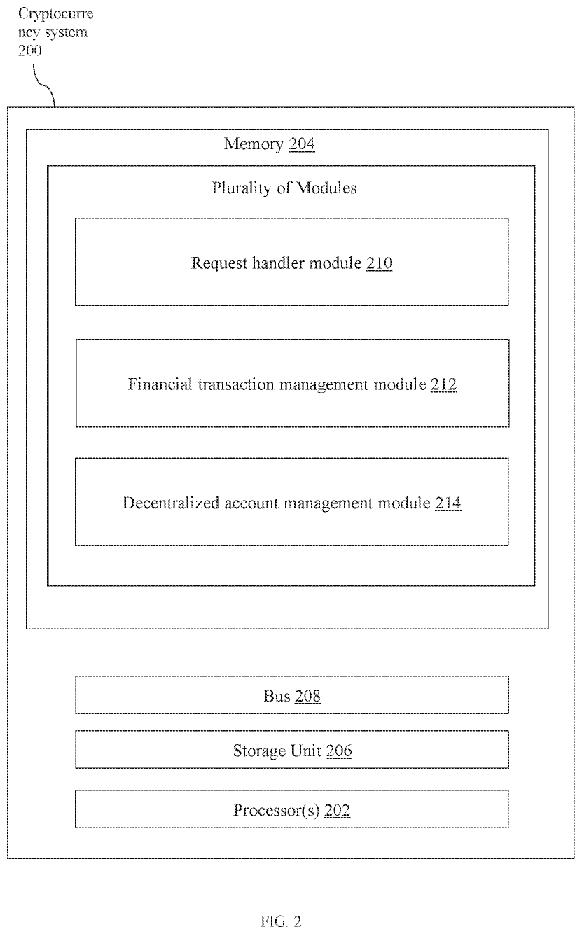

FIG. 1 is a block diagram illustrating an exemplary block chain network 100 for managing financial transactions in accordance with an embodiment of the present disclosure. According to FIG. 1, the blockchain network 100 comprises one or more nodes 102A-F interconnected with each other. Each of the one or more nodes 102A-F acts as a cryptocurrency system, as described in detail in FIG. 2. The one or more nodes 102A-F is configured for performing a financial transaction.

Although FIG. 1 illustrates the blockchain network 100 comprising the one or mode nodes 102A-F, one skilled in the art can envision that the blockchain network 100 can comprise further unlimited nodes interconnected with each other.

Those of ordinary skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art w % ill recognize that, for simplicity and clarity, the full structure and operation of all data processing systems suitable for use with the present disclosure is not being depicted or described herein. Instead, only so much of a blockchain network 100 as is unique to the present disclosure or necessary for an understanding of the present disclosure is depicted and described. The remainder of the construction and operation of the blockchain network 100 may conform to any of the various current implementation and practices known in the art.

FIG. 2 is a block diagram illustrating an exemplary cryptocurrency system 200, such as those shown in FIG. 1, capable of performing financial transactions, in accordance with an embodiment of the present disclosure. In FIG. 2, the cryptocurrency system 200, such as the one or more nodes 102A-F shown in FIG. 1, comprises a processor 202, a memory 204, and a database 206. The processor 202, the memory 204 and the database 206 are communicatively coupled through a system bus 208 or any similar mechanism. The memory 204 comprises a plurality of modules in the form of programmable instructions executable by the one or more processors 202. The plurality of modules further includes a request handler module 210, a financial transaction management module 212, and a decentralized account management module 214.

The processor(s) 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The processor(s) 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the processor(s) 202, such as being a computer-readable storage medium. The processor(s) 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes a plurality of modules stored in the form of machine-readable instructions on any of the above-mentioned storage media and may be in communication with and executed by the processor(s) 202.

The request handler module 210 is configured for receiving a request for performing a financial transaction with respect to a decentralized account associated with a sender and first set of parties. Each of the sender and the first set of parties own a secret share key of an account private key associated with the decentralized account. The financial transaction comprises transferring of funds from one decentralized account to another decentralized account or a non-decentralized account. The secret share key is a portion of the account private key. The terms ‘first set of parties’ and N parties are used interchangeably throughout the document.

In a case, where a sender who no longer wishes to use decentralized accounts, the sender may downgrade the decentralized accounts to non-decentralized accounts. This likely happens when the sender wishes to transfer money to a receiver who does not trust that some of the sender's N parties can prevent double-spending attacks. In such embodiment of the present disclosure, the request handler module 210 is further configured for receiving a request for performing the financial transaction with respect to a decentralized account from the sender. The request handler module 210 then forwards the request to the N parties. The sender and the first set of parties own secret share key of the account private key associated with the decentralized account. In such case, the secret share key of the account private key is transferred from the first set of parties to the sender by executing key reconstruction protocol and later the account private key is reconstructed at the sender side by merging the secret share key of the sender with the secret share key transferred from the first set of parties. Hence, the sender alone has the full account private key.

The financial transaction management module 212 is configured for performing the financial transaction by transferring the secret share key associated with each of the sender and the first set of parties to at least one of a recipient and a second set of parties. Specifically, in performing the financial transaction by transferring the secret share key associated with each of the sender and the first set of parties to the at least one of the recipient and the second set of parties, the financial transaction management module 212 is configured for executing a secure protocol between the sender and the first set of parties and transferring the secret share key associated with each of the sender and the first set of parties to the at least one of the recipient and the second set of parties based on the executed secure protocol.

Further, in performing the financial transaction by transferring the secret share key associated with each of the sender and the first set of parties to the recipient, the financial transaction management module 212 is configured for transferring complete funds within the decentralized account to the recipient and the second set of parties. Before performing the financial transaction by transferring the secret share key associated with each of the sender and the first set of parties to the recipient and the second set of parties, the financial transaction management module 212 is configured for obtaining a consent for performing the financial transaction from the sender and the first set of parties, the recipient and the second set of parties and then performing the financial transaction by transferring the secret share key associated with each of the sender and the first set of parties to the recipient and the second set of parties.

In one embodiment of the present disclosure, in performing the financial transaction by transferring the secret share key associated with each of the sender and the first set of parties to the at least one of the recipient and the second set of parties, the financial transaction management module 212 is configured for transferring funds to the generated set of decentralized accounts from at least one of an existing decentralized accounts and existing non-decentralized accounts. The funds are transferred using a blockchain transaction.

In case where the sender owns multiple decentralized accounts, the financial transaction management module 212 is further configured for determining funds to be transferred for performing the financial transaction. Further, the financial transaction management module 212 is configured for determining subset out of set of decentralized accounts associated with the sender based on the determined funds to be transferred. A total balance in the determined subset of decentralized account matches the determined funds to be transferred. Also, the financial transaction management module 212 is further configured for performing the financial transaction by transferring the secret share key associated with each of the sender and the first set of parties corresponding to the determined subset of decentralized accounts to the at least one of the recipient and the second set of parties.

In case where the sender alone requests for full access to the account private key, the financial transaction management module 212 is further configured for transferring the secret share key of the account private key from the first set of parties to the sender by executing key reconstruction protocol.

The decentralized account management module 214 is configured for recovering the account private key at the recipient and the second set of parties' side using the transferred secret share key associated with each of the sender and the first set of parties and discarding the secret share key of the account private key at the sender and the first set of parties' side upon recovering the account private key at the recipient side and the second set of parties' side.

In an embodiment of the present disclosure, the decentralized account management module 214 is configured for obtaining a consent for generating a set of decentralized accounts from each of the sender and the first set of parties. The set of decentralized account is jointly owned by the sender and the first set of parties. Further, the decentralized account management module 214 is configured for generating the set of decentralized accounts by executing a secure protocol at the sender side and the first set of parties' side. The generated set of decentralized accounts comprises an address in a cryptocurrency system with a fund as balance.

In an embodiment of the present disclosure, the decentralized account management module 214 further comprises a key management module configured for generating a set of account private keys corresponding to the generated set of decentralized accounts. Each of the set of account private keys comprises a group of secret share keys. Further, the key management module is configured for distributing the group of the secret-share keys associated with each of the generated set of account private keys between the sender and the first set of parties based on a predefined share-key policy. Each secret share key among the group of the secret share keys corresponds to a portion of respective account private key corresponding to respective decentralized account.

In an embodiment of the present disclosure, the decentralized account management module 214 is further configured for reconstructing the account private key at the sender side by merging the secret share key of the sender with the secret share key transferred from the first set of parties.

The storage unit 206 stores the information relating to the account private keys on temporary basis. The storage unit 206, according to another embodiment of the present disclosure, is a location on a file system directly accessible by the plurality of modules. The storage unit 206 is also responsible for caching and regular updating of node data. The storage unit 206 stores decentralized account addresses, and balance of each decentralized accounts.

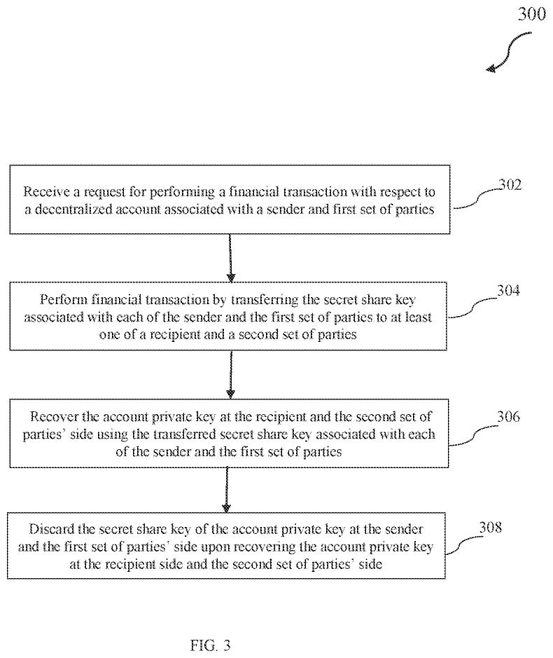

FIG. 3 is a process flow diagram illustrating an exemplary cryptocurrency-based method 300 for performing financial transactions, in accordance with an embodiment of the present disclosure. At step 302, a request for performing a financial transaction is received with respect to a decentralized account associated with a sender and first set of parties. Each of the sender and the first set of parties own a secret share key of an account private key associated with the decentralized account. At step 304, the financial transaction is performed by transferring the secret share key associated with each of the sender and the first set of parties to at least one of a recipient and a second set of parties. At step 306, the account private key is recovered at the recipient and the second set of parties' side using the transferred secret share key associated with each of the sender and the first set of parties. At step 308, the secret share key of the account private key is discarded at the sender and the first set of parties' side upon recovering the account private key at the recipient side and the second set of parties' side.

In receiving the request for performing the financial transaction with respect to the decentralized account associated with the sender and the first set of parties, the cryptocurrency-based method 300 includes obtaining a consent for generating a set of decentralized accounts from each of the sender and the first set of parties. The set of decentralized account is jointly owned by the sender and the first set of parties. Further, the cryptocurrency-based method 300 includes generating the set of decentralized accounts by executing a secure protocol at the sender side and the first set of parties' side. The generated set of decentralized accounts comprises an address in a cryptocurrency system with a fund as balance. Further. the cryptocurrency-based method 300 includes generating a set of account private keys corresponding to the generated set of decentralized accounts. Each of the set of account private keys comprises a group of secret share keys. Further, cryptocurrency-based method 300 includes distributing the group of the secret-share keys associated with each of the generated set of account private keys between the sender and the first set of parties based on a predefined share-key policy. Each secret share key among the group of the secret share keys corresponds to a portion of respective account private key corresponding to respective decentralized account.

In performing the financial transaction by transferring the secret share key associated with each of the sender and the first set of parties to the at least one of the recipient and the second set of parties, the cryptocurrency-based method 300 includes transferring funds to the generated set of decentralized accounts from at least one of an existing decentralized accounts and existing non-decentralized accounts. The funds are transferred using a blockchain transaction.

In performing the financial transaction by transferring the secret share key associated with each of the sender and the first set of parties to the at least one of the recipient and the second set of parties, the cryptocurrency-based method 300 includes executing a secure protocol between the sender and the first set of parties and transferring the secret share key associated with each of the sender and the first set of parties to the at least one of the recipient and the second set of parties based on the executed secure protocol.

In transferring the secret share key associated with each of the sender and the first set of parties to a recipient by executing a secure protocol between the sender and the first set of parties, the cryptocurrency-based method 300 includes transferring complete funds within the decentralized account to the recipient and the second set of parties.

In performing the financial transaction by transferring the secret share key associated with each of the sender and the first set of parties to the recipient and the second set of parties. the cryptocurrency-based method 300 includes obtaining a consent for performing the financial transaction from the sender and the first set of parties, the recipient and the second set of parties; and performing the financial transaction by transferring the secret share key associated with each of the sender and the first set of parties to the recipient and the second set of parties.

The cryptocurrency-based method 300 further includes receiving a request for performing the financial transaction with respect to a decentralized account from the sender. The sender and the first set of parties own secret share key of the account private key associated with the decentralized account. Further, the cryptocurrency-based method 300 includes transferring the secret share key of the account private key from the first set of parties to the sender by executing key reconstruction protocol. Furthermore. the cryptocurrency-based method 300 includes reconstructing the account private key at the sender side by merging the secret share key of the sender with the secret share key transferred from the first set of parties.

The cryptocurrency-based method 300 further includes determining funds to be transferred for performing the financial transaction. Also, the cryptocurrency-based method 300 further includes determining subset out of set of decentralized accounts associated with the sender based on the determined funds to be transferred. A total balance in the determined subset of decentralized account matches the determined funds to be transferred. Furthermore, the cryptocurrency-based method 300 further includes performing the financial transaction by transferring the secret share key associated with each of the sender and the first set of parties corresponding to the determined subset of decentralized accounts to at least one of the recipient and the second set of parties.

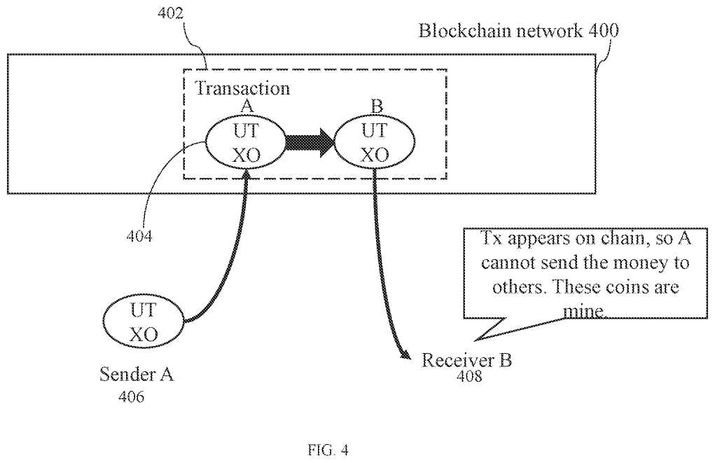

FIG. 4 is a schematic representation of blockchain network 400 depicting process of performing financial transactions, in accordance with an embodiment of the present disclosure. The blockchain network 400 comprises many accounts and transactions. An account has the ability to transfer coins to another account (e.g., of another user B 408) from unspent transactions (called UTXO) 404 under sender's account. Conventionally, to transfer the coins, the sender A 406 creates a transaction 402 and posts it on the blockchain network. The requirement that the sender A 406 must post it on the blockchain network 400 is to avoid double-spending attack. However, the present disclosure, as per FIG. 4, focuses on preventing the double-spending attack, by preventing the need to post a transaction 402 on the blockchain network 400, and thereby avoiding the transaction fee.

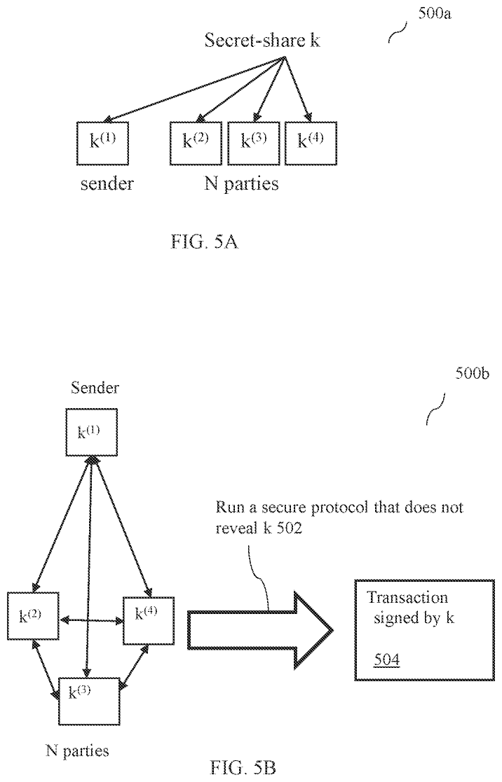

FIG. 5A-B is a schematic representation depicting a process of performing financial transaction, in accordance with another embodiment of the present disclosure. As shown in FIG. 5A, a sender has coins in many different accounts, where each account has some money. Unlike the conventional systems, these accounts are controlled by more than one party: the sender and ‘N’ parties (also referred herein as first set of parties throughout the specification). The N parties may consist of several institutions, such as Coinbase and other cryptocurrency companies, as well as cloud platform companies such as Amazon and the like. It is assumed that at least some of these N parties are trustworthy in that they do not participate in a double-spending attack. Such accounts are referred herein as “decentralized accounts”. The sender is not given access to full account private keys. Hence the sender does not have full control on these accounts. Instead, the sender and the N parties each have a secret-share key of the account private key, as shown in FIG. 5A. Secret-sharing is referred herein as follows. The sender and the N parties each have a value, called the secret-share key, which consists of partial information of the account private key. The secret-sharing scheme defines a policy over “how many shares and what shares are sufficient to reconstruct the account private key”. For example, a policy may be “reconstruction requires sender and at least two of the N parties”. Hence, k1, k2, k3 are used to reconstruct the key, however not k1, k2 or k2, k3, k4. This means that if the sender does not approve, the three parties above cannot reconstruct the account private key, and their secret share keys are not useful in this case. There are many possible policies. The present disclosure supports any policy as long as there is a secret-sharing scheme for that policy.

According to FIG. 5B, when the sender and the N parties agree to make a transfer, at step 502, the sender and the N parties run a protocol such that they generate a desired transaction 504 (with the corresponding signature under the account private key), while none of them is aware of the account private key ‘k’ after running this protocol. This protocol may be any known protocol capable of producing this transaction, which is signed under the account private key k, without revealing the key k, such as general-purpose secure multiparty computation.

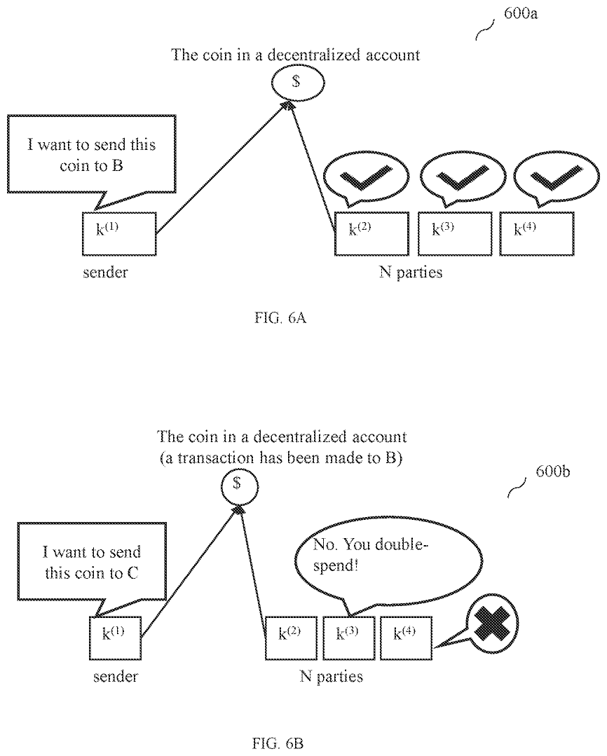

FIG. 6A-B is a schematic representation depicting a process of preventing double-spending attack, in accordance with an embodiment of the present disclosure. According to FIG. 6A, when a sender wishes to make a transfer, the sender cannot do that on his own. Instead, the sender works together with the N parties. It is assumed herein that at least some of these N parties are trustworthy enough to refuse to participate in double-spending attacks. Many parties may take this role, such as another cryptocurrency company, the trusted execution environments by Intel, and the trusted enclaves by Amazon Cloud Services and the like. In an exemplary embodiment, consider these N parties to be police or notary. According to FIG. 6B, even if the sender may corrupt a few of the N parties, some of the N parties still follow the system design, in that if it is determined that the sender is starting a double-spending attack (making transfer of transactions that have previously been transferred in the protocol), some of the N parties refuse to participate in the protocol above, and therefore the transaction is not created, and the double spending does not occur. This depicts how a decentralized account can prevent double-spending attacks.

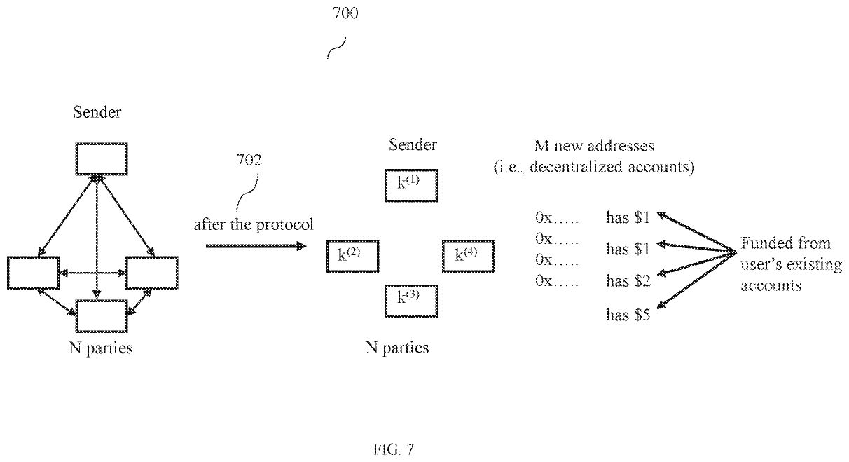

FIG. 7 is a block diagram illustrating an exemplary process 700 for generating decentralized accounts, in accordance with an embodiment of the present disclosure. According to an embodiment of the present disclosure, there are two ways for a sender to obtain decentralized accounts. Firstly, by receiving existing decentralized accounts by being transferred the ownership to from someone else, or secondly by creating new decentralized accounts from scratch and funding these new accounts from existing non-decentralized accounts. Below is the explanation for converting existing non-decentralized accounts to decentralized accounts.

This conversion would incur a transaction fee and take time for confirmation. However, later when the sender transfers the money by transferring the ownership of decentralized accounts. there would not be a need to pay transaction fees or wait for confirmation, hence the conversion cost is considered as one-time cost to create accounts from scratch. In this specific embodiment, at step 702, the sender and N parties run a decentralized key generation protocol to create ‘M’ new decentralized accounts, which are then funded by the sender. The decentralized key generation protocol may be any protocol that fulfils the following requirements. After running the protocol, the sender and the N parties is aware of the M decentralized accounts' public keys (i.e., addresses), which are the account private keys. After the protocol, the sender and the N parties each have one secret share key of the account private keys of each of the M decentralized accounts. The entire cryptocurrency system 200 therefore has (1+N)*M secret share keys of the account private keys. The left-to-middle part of the FIG. 7 illustrates the decentralized key generation protocol above. Now, there are M decentralized accounts, however none of them has coins. As the second step, the sender funds these decentralized accounts, by sending money from the sender's existing non-decentralized account (e.g., any normal account in the cryptocurrency system) to these M addresses, such that each address or the decentralized account now has some coins in it. This is done by a normal blockchain transaction; hence it incurs a transaction fee and requires a confirmation for the blockchain transaction. This is a one-time cost.

In summary, for generating the decentralized accounts and funding them, there are three phases, firstly an agreement phase where the sender and the N parties agree to create some decentralized accounts, secondly a decentralized key generation phase where the sender and the N parties run some protocol to generate M new accounts and receive secret-share keys of the account private keys of these accounts and lastly a funding phase where the sender makes a standard blockchain transaction to send money to these M new accounts.

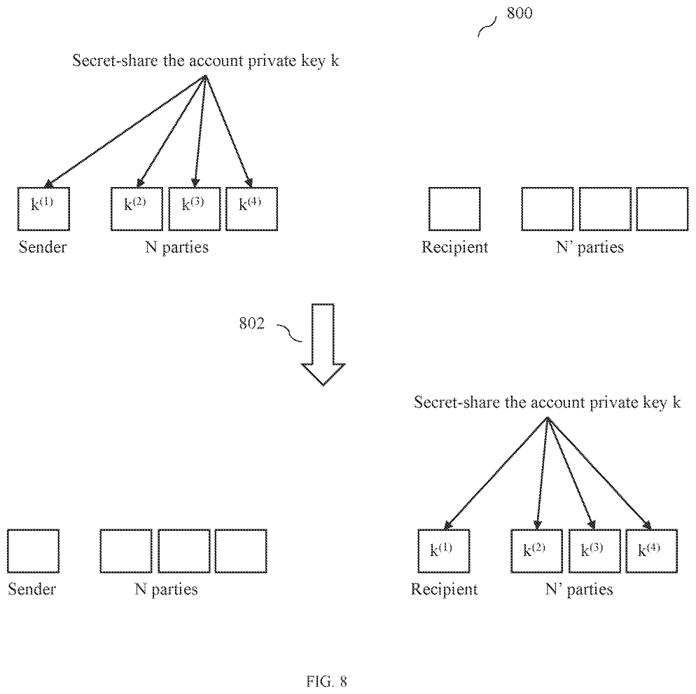

FIG. 8 is a block diagram illustrating an exemplary process 800 for transferring secret share keys from a sender and first set of parties to a recipient and a second set of parties, in accordance with an embodiment of the present disclosure. According to FIG. 8, a sender has some decentralized accounts. Consider that the sender requests to send money in these accounts to a recipient. The money in an account needs to be sent out in whole, in other words, the sender transfers the ownership of one or more account to the recipient. On the sender or sender side, there exists a sender and N parties, who are the holders of the secret-share keys of the M decentralized accounts in action. On the receiver side, there exists a recipient and N′ parties, who wishes to receive the secret-share keys of the decentralized accounts above. The N parties need not be equal to N′ parties. Specifically. N′ parties may be 0′, in which case the recipient receives all the secret share keys, and the account is no longer decentralized. Also, the recipient needs to trust that at least some of the N parties (on the sender side) are trustworthy such that these N parties do not participate in a double-spending attack. This ensures that the recipient actually obtains the decentralized accounts. The transfer is done in a key-resharing protocol among the two users (the sender and the recipient) and N+N′ parties. If there are overlapping between the N parties and N′ parties, it is assumed that N+N′ parties play both roles in the protocol. For example, the key-resharing protocol may be a general-purpose secure multiparty computation or any other protocol known in the art.

Upon running this key resharing protocol at step 802, the recipient and the N′ parties obtain new secret share keys (denoted by k′(1), k′(2), k′(3), k′(4)) of the account private key k. This is the same key k as the one originally secret-shared by the sender and the N parties. The new secret share keys may be different from the old secret share keys or may also be the same.

Further, upon running this key resharing protocol at step 802, the recipient is certain that the secret share keys owned by the recipient and the N′ parties are used to recover the same account private key k. corresponding to an address in the cryptocurrency system 200 with a specific amount as the balance.

Furthermore, upon running this key resharing protocol at step 802, the recipient is certain that some of the N parties have successfully discarded its share of the secret share key, such that the sender and the N parties may no longer reconstruct the account private key k using the remaining shares, if any.

The money in the decentralized accounts are always sent in whole. Hence, if a sender wishes to send $20, the cryptocurrency system determines several decentralized accounts such that the total balance is exactly $20.

Eventually, as a result of the computation above, the recipient and the N′ parties now have the secret share keys of the decentralized accounts. In other words, the recipient now owns the coins, though he/she needs to work with the N′ parties to perform more transfers. This process does not require a transaction fee, as there are no blockchain transactions being generated. In addition, this process is confirmed very quickly. as the protocol is all what the sender and the receiver need. This protocol is also decentralized, as no single entity knows the key.

If N′=0, this is the special case where the recipient is now the sole entity of the account private key. The previously decentralized account now becomes a normal cryptocurrency account, where the recipient uses the account similar to those in the original cryptocurrency system. The recipient, in this case, can no longer transfer the ownership of the decentralized accounts to someone else, and money transfer would need to follow the traditional cryptocurrency protocol, which uses a blockchain transaction.

In summary, this protocol can be considered as two phases, firstly an agreement phase where the sender and the N parties, as well as the recipient and the N′ parties, agree to perform this transfer. This means that the recipient trusts that some of the N parties would refuse to participate if there is a double-spending attack, and the fact that the N parties agree to do so means this transfer would not be a double spending. Second is a key resharing phase, where the sender and the N parties, as well as the recipient and the N′ parties, run the key resharing protocol, such that the recipient and the N′ parties have the secret share keys of the account private key.

In an additional embodiment, a sender who no longer wishes to use decentralized accounts may downgrade the decentralized accounts to non-decentralized accounts. This likely happens when the sender wishes to transfer money to a receiver who does not trust that some of the sender's N parties prevents double-spending attacks. To achieve this, the sender contacts the N parties, the N parties then run a key reconstruction protocol, which fulfils the following requirements:

(1) after running the protocol, the sender receives all the secret share keys of the account private key k, which allows the sender to spend the money in the accounts directly; and

(2) after running the protocol, the N parties forget or discard the secret share keys.

In summary, this protocol can be considered as two phases, firstly, an agreement phase, where the sender and the N parties, as well as the recipient and the N′ parties, agree to perform this transfer. This means that the recipient trusts that some of the N parties would refuse to participate if there is a double-spending attack, and the fact that the N parties agree to do so means this transfer would not be a double spending. Second is a key reconstruction phase, where the sender and the N parties run the key reconstruction protocol, such as the sender now has the account private key.

Various embodiments of the present system provide a technical solution to the problem of preventing double-spending attack in cryptocurrency systems, avoiding transaction fees incurred for a transaction and reduce or avoid confirmation time required for the transaction to be confirmed on the blockchain network. In the present system, instead of transferring the money, the sender and the N parties send the account private key to the receiver. The N parties forget the secret share key later, such that the receiver has the full ownership of the coins in the account. As long as the receiver trusts that some of the N parties are trustworthy, they can be certain that there is nobody else who can spend money in that account, and the receiver owns those coins. To achieve this, first, all the coins in a decentralized account are transferred. Further, it is considered that the sender has many decentralized accounts, each of the which has some small amounts of money. To transfer, for example, $20, the sender selects a subset of his or her decentralized accounts such that the total balance in these accounts are $20. Second, this protocol avoids transaction fees, provides fast confirmation, and is decentralized. Since there is no actual transaction being created, there are no transaction fees. The confirmation is also quick because the receiver does not need to wait for the block containing the transaction to be finalized on the blockchain (to avoid suffering double-spending attacks). The present system is also decentralized, as one or even some of the N parties, even if they collude with each other or are compromised by the same attacker, would not be able to spend the user's money without the user's approval.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM). compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A cryptocurrency system for performing financial transactions, the cryptocurrency system comprising:
one or more hardware processors; and
a memory coupled to the one or more hardware processors, wherein the memory comprises a plurality of modules in the form of programmable instructions executable by the one or more hardware processors, wherein the plurality of modules comprises:
a request handler module configured for receiving a request for performing a financial transaction with respect to a decentralized account associated with a sender and first set of parties, wherein each of the sender and the first set of parties own a secret share key of an account private key associated with the decentralized account;
a financial transaction management module configured for performing the financial transaction by transferring the secret share key associated with each of the sender and the first set of parties to at least one of a recipient and a second set of parties,
a decentralized account management module configured for:
recovering the account private key at the recipient and the second set of parties' side using the transferred secret share key associated with each of the sender and the first set of parties; and
discarding the secret share key of the account private key at the sender and the first set of parties' side upon recovering the account private key at the recipient side and the second set of parties' side.

2. The cryptocurrency system of claim 1, wherein the decentralized account management module is further configured for:
obtaining a consent for generating a set of decentralized accounts from each of the sender and the first set of parties, wherein the set of decentralized account is jointly owned by the sender and the first set of parties; and
generating the set of decentralized accounts by executing a secure protocol at the sender side and the first set of parties' side.

3. The cryptocurrency system of claim 2, wherein the decentralized account management module further comprises a key management module configured for:
generating a set of account private keys corresponding to the generated set of decentralized accounts, wherein each of the set of account private keys comprises a group of secret share keys; and
distributing the group of the secret-share keys associated with each of the generated set of account private keys between the sender and the first set of parties based on a predefined share-key policy, wherein each secret share key among the group of the secret share keys corresponds to a portion of respective account private key corresponding to respective decentralized account.

4. The cryptocurrency system of claim 1, wherein the generated set of decentralized accounts comprises an address in a cryptocurrency system with a fund as balance.

5. The cryptocurrency system of claim 1, wherein in performing the financial transaction by transferring the secret share key associated with each of the sender and the first set of parties to the at least one of the recipient and the second set of parties, the financial transaction management module configured for:
transferring funds to the generated set of decentralized accounts from at least one of an existing decentralized accounts and existing non-decentralized accounts, wherein the funds are transferred using a blockchain transaction.

6. The cryptocurrency system of claim 1, wherein in performing the financial transaction by transferring the secret share key associated with each of the sender and the first set of parties to the at least one of the recipient and the second set of parties, the financial transaction management module configured for:
executing a secure protocol between the sender and the first set of parties; and
transferring the secret share key associated with each of the sender and the first set of parties to the at least one of the recipient and the second set of parties based on the executed secure protocol.

7. The cryptocurrency system of claim 1, wherein in performing the financial transaction by transferring the secret share key associated with each of the sender and the first set of parties to the recipient, the financial transaction management module configured for;
transferring complete funds within the decentralized account to the recipient and the second set of parties.

8. The cryptocurrency system of claim 1, wherein in performing the financial transaction by transferring the secret share key associated with each of the sender and the first set of parties to the recipient and the second set of parties, the financial transaction management module configured for:
obtaining a consent for performing the financial transaction from the sender and the first set of parties, the recipient and the second set of parties; and
performing the financial transaction by transferring the secret share key associated with each of the sender and the first set of parties to the recipient and the second set of parties.

9. The cryptocurrency system of claim 1, wherein the cryptocurrency system further comprises:
the request handler module further configured for receiving a request for performing the financial transaction with respect to a decentralized account from the sender, wherein the sender and the first set of parties own secret share key of the account private key associated with the decentralized account;
the financial transaction management module further configured for transferring the secret share key of the account private key from the first set of parties to the sender by executing key reconstruction protocol; and
the decentralized account management module further configured for reconstructing the account private key at the sender side by merging the secret share key of the sender with the secret share key transferred from the first set of parties.

10. The cryptocurrency system of claim 1, wherein the financial transaction management module is further configured for:
determining funds to be transferred for performing the financial transaction;
determining subset out of set of decentralized accounts associated with the sender based on the determined funds to be transferred, wherein total balance in the determined subset of decentralized account matches the determined funds to be transferred; and
performing the financial transaction by transferring the secret share key associated with each of the sender and the first set of parties corresponding to the determined subset of decentralized accounts to the at least one of the recipient and the second set of parties.

11. A cryptocurrency-based method for performing financial transactions in cryptocurrency systems, the cryptocurrency-based method comprising:
receiving, by a processor, a request for performing a financial transaction with respect to a decentralized account associated with a sender and first set of parties, wherein each of the sender and the first set of parties own a secret share key of an account private key associated with the decentralized account;
performing, by the processor, the financial transaction by transferring the secret share key associated with each of the sender and the first set of parties to at least one of a recipient and a second set of parties;
recovering, by the processor, the account private key at the recipient and the second set of parties' side using the transferred secret share key associated with each of the sender and the first set of parties; and
discarding, by the processor, the secret share key of the account private key at the sender and the first set of parties' side upon recovering the account private key at the recipient side and the second set of parties' side.

12. The cryptocurrency-based method of claim 11, wherein receiving the request for performing the financial transaction with respect to the decentralized account associated with the sender and the first set of parties comprises:
obtaining a consent for generating a set of decentralized accounts from each of the sender and the first set of parties, wherein the set of decentralized account is jointly owned by the sender and the first set of parties:
generating the set of decentralized accounts by executing a secure protocol at the sender side and the first set of parties' side;
generating a set of account private keys corresponding to the generated set of decentralized accounts, wherein each of the set of account private keys comprises a group of secret share keys;
distributing the group of the secret-share keys associated with each of the generated set of account private keys between the sender and the first set of parties based on a predefined share-key policy, wherein each secret share key among the group of the secret share keys corresponds to a portion of respective account private key corresponding to respective decentralized account.

13. The cryptocurrency-based method of claim 11, wherein the generated set of decentralized accounts comprises an address in a cryptocurrency system with a fund as balance.

14. The cryptocurrency-based method of claim 11, wherein performing the financial transaction by transferring the secret share key associated with each of the sender and the first set of parties to the at least one of the recipient and the second set of parties comprises:
transferring funds to the generated set of decentralized accounts from at least one of an existing decentralized accounts and existing non-decentralized accounts, wherein the funds are transferred using a blockchain transaction.

15. The cryptocurrency-based method of claim 11, wherein performing the financial transaction by transferring the secret share key associated with each of the sender and the first set of parties to the at least one of the recipient and the second set of parties comprises:
executing a secure protocol between the sender and the first set of parties; and
transferring the secret share key associated with each of the sender and the first set of parties to the at least one of the recipient and the second set of parties based on the executed secure protocol.

16. The cryptocurrency-based method of claim 11, wherein transferring the secret share key associated with each of the sender and the first set of parties to a recipient by executing a secure protocol between the sender and the first set of parties comprises:
transferring complete funds within the decentralized account to the recipient and the second set of parties.

17. The cryptocurrency-based method of claim 11, wherein performing the financial transaction by transferring the secret share key associated with each of the sender and the first set of parties to the recipient and the second set of parties comprises:
obtaining a consent for performing the financial transaction from the sender and the first set of parties, the recipient and the second set of parties; and
performing the financial transaction by transferring the secret share key associated with each of the sender and the first set of parties to the recipient and the second set of parties.

18. The cryptocurrency-based method of claim 11, further comprising:
receiving a request for performing the financial transaction with respect to a decentralized account from the sender, wherein the sender and the first set of parties own secret share key of the account private key associated with the decentralized account;
transferring the secret share key of the account private key from the first set of parties to the sender by executing key reconstruction protocol; and
reconstructing the account private key at the sender side by merging the secret share key of the sender with the secret share key transferred from the first set of parties.

19. The cryptocurrency-based method of claim 11, further comprising:
determining funds to be transferred for performing the financial transaction;
determining subset out of set of decentralized accounts associated with the sender based on the determined funds to be transferred, wherein total balance in the determined subset of decentralized account matches the determined funds to be transferred; and
performing the financial transaction by transferring the secret share key associated with each of the sender and the first set of parties corresponding to the determined subset of decentralized accounts to the at least one of the recipient and the second set of parties.

20. A non-transitory computer-readable storage medium having instructions stored therein that, when executed by a hardware processor, cause the processor to perform the method steps comprising:
receiving a request for performing a financial transaction with respect to a decentralized account associated with a sender and first set of parties, wherein each of the sender and the first set of parties own a secret share key of an account private key associated with the decentralized account;
performing the financial transaction by transferring the secret share key associated with each of the sender and the first set of parties to at least one of a recipient and a second set of parties;
recovering the account private key at the recipient and the second set of parties' side using the transferred secret share key associated with each of the sender and the first set of parties; and
discarding the secret share key of the account private key at the sender and the first set of parties' side upon recovering the account private key at the recipient side and the second set of parties' side.
